(19) United States
(12) Patent Application Publication
(10) Pub. No.: US 2013/0021788 A1
(43) Pub. Date: Jan. 24, 2013

(54) Personal Energy Christmas Ornaments

(71) Applicant: Willard Alan Mayes, Dallas, TX (US)

(72) Inventor: Willard Alan Mayes, Dallas, TX (US)

(21) Appl. No.: 13/550,644

(22) Filed: Jul. 17, 2012

Related U.S. Application Data
(60) Provisional application No. 61/572,789, filed on Jul. 19, 2011.

(51) Int. Cl. F21L 4/00

(52) U.S. Cl. 362/183

(57) ABSTRACT

A method is disclosed for personalizing a Christmas ornament by associating the ornament with a store of energy harvested from the body of at least one person and/or animal subject. An energy storage device charged with the harvested energy, referred to as “personal energy” herein, is operatively associated with an electronic device comprised in a Christmas ornament. The ornament can be additionally personalized with conventional personalization elements, such as indicia or photography, to identify and further associate with the Christmas ornament the person and/or animal whose energy powers the ornament's electronic device. The especially intimate nature of harvested personal energy enhances the sentimental and social expression values of the Christmas ornament.

### FIELD OF THE INVENTION

The present invention relates to holiday adornments, and more particularly personalized Christmas ornaments. The present invention is tangentially related to energy harvesting from human or animal sources.

### BACKGROUND OF THE INVENTION

Christmas ornaments are cherished by many as embodiments of the intangible “Christmas spirit” they've shared with loved ones over the years. Similarly, an ornament that is identified with a particular loved one seems imbued with that individual's enduring personal spirit, a kind of intangible personal energy that is sensed and experienced once more each time the ornament is added to successive Christmas trees. Thus, Christmas ornaments have long been personalized with markings or indicia to associate them with particular persons; or, in some cases, particular pet animals. From the 20^{th} century, this association has been enhanced with photography added to or printed on Christmas ornaments. And in recent years, electronic media features, such as audio/video recordings of personal greetings or digital displays of personal photographs have further enhanced the intrinsic sentimental value of personalized Christmas ornaments.

However, while progressively associating a particular person (or beloved animal) with a particular Christmas ornament, these innovative steps in Christmas ornament personalization methods are still only representations of the person or animal's character and spirit. A person beholding a prior art Christmas ornament of the like may sense the presence of their loved one's “life energy” in or about the ornament, but because it is not discernible by any of the five human senses, many would argue that the presence of such personal energy is not certain. This uncertainty represents a shortcoming in prior art Christmas ornaments, a shortcoming that could be addressed only by improvements that would make it possible to somehow include in a Christmas ornament the actual energy of the person or animal associated with the ornament and to evince this energy such that it could be experienced by one or more of the human senses and thus shown to actually reside in the ornament. The present invention teaches methods and suggests means for achieving these improvements.

An essential element of the methods disclosed herein is energy harvesting from human or animal sources, an energy which this invention refers to as “personal energy”. One general approach to personal energy harvesting is to employ micro-energy harvesting devices. Usually made of thin-film materials, micro-energy harvesting devices, which harvest very small amounts of energy collected over an extended period; for example, thin-film piezoelectric and thermoelectric generator modules. Micro-energy harvesting, alternately referred to as “micro-harvesting,” is essentially a passive form of harvesting that can require little intentional effort from the subject. Furthermore, the harvesting subject can wear micro-harvesting devices without interference to their movement; thus, the thermal or kinetic energy of even very active subjects, such as athletes actively engaged in sports or construction workers going about their work, could be harvested. Conversely, the personal energy of a weak or incapacitated person or animal could be passively harvested with one or more types of micro-harvesting devices.

Another solution is the use of a manually operated mechanical electric generator, whereby a person or animal mechanically inputs and converts their muscle energy (biomechanical energy) to electrical power. While the term “energy harvesting” has come for many to reference only today's micro-energy harvesting technology, in fact some energy harvesters are large mechanisms and have been around for a very long time; windmills, for example. A manually operated mechanical electrical generator is a personal energy harvester; it captures the energy of the operator and translates the energy to useful electrical power. It can generate a vastly greater amount of electrical energy than a micro-harvesting device, and in a far shorter period of time. This could appeal as a convenience factor to some, especially those who would like to harvest a large store of energy from a human or animal source. In contrast to micro-harvesting methods, harvesting personal energy with a manually operated generator would normally require the person or animal's active participation.

There exists various electronic devices that harvest energy from the body of a living human being or animal; examples can be found in a wide range of applications, from implanted medical devices to wristwatches. However, prior art in every field teaches harvesting doing so for a practical purpose: to use the harvested energy to power or augment the power to an electronic device. The harvested energy is treated no differently from any other source of electricity, as the purpose of the electronic device it powers is not to serve as a medium for the sharing of the personal energy and not to use the energy to personalize an item, but rather to accomplish a task that the electronic device is separately designed to carry out and is able to complete with any suitable source of electrical power.

In contrast to the intellectual, utilitarian approach of prior art, the present invention teaches harvesting personal energy for aesthetic purposes: to facilitate social expression, communication of emotions and arousal of sensations. The present invention, therefore, represents not only an improvement to the art of Christmas ornaments, but also a new perspective on the intrinsic worth of energy harvested from human or animal sources.

There is mentioned in prior art a Christmas ornament that is part of a system that inadvertently includes a method by which a person's harvested personal energy could power an electronic component comprised by the ornament. Ballarini et al. (U.S. Pat. No. 7,249,863) discloses a solar-powered “tree topper” Christmas ornament that proposes a backup manually operated external charger and suggests a hand crank or foot pedal action to drive an electrical generator to recharge a battery otherwise charged by the electrical output of photovoltaic cells. As the energy generated by such a backup manual device would be expended by the body of the person (or animal, feasibly) who operated it, the energy provided to the battery is, by the definition used in the present invention, harvested personal energy. However, it is clear from the abstract, the specifications and the claims of Ballarini et al. that the invention does not intend to provide a user with a store of personal energy, does not intend to personalize the tree topper ornament with the energy generated by the manually operated devices, and assigns no aesthetic nor sentimental value to the energy produced in the backup process, while viewing such energy as secondary to the primary and defining solar power feature of the invention.

An example of harvested energy used to power lights adorning a Christmas tree is seen in Greene et al. (U.S. Pat. No. 7,898,105) wherein LED lights mounted on a Christmas tree are powered by a system that harvests the energy of radio frequency (RF) power. It is possible that a person or animal could expend energy to actuate a device that generates RF energy and that energy could be viewed as personal energy as defined in this disclosure; however, it is clearly not the intent of the Greene et al. to harvest energy from the living body of a person or animal and use that energy to personalize a Christmas ornament.

### SUMMARY

It is the object of the present invention to propose methods for enhancing a Christmas ornament by personalizing it with a store of personal energy harvested from the living body or bodies of one or more persons and/or animals who are associated with the ornament. Personal energy is defined for purposes of this disclosure as the energy naturally translated by the living body of a human being or animal subject, such as thermal or kinetic energy. The methods teach operatively associating a store of the subject's harvested personal energy with an electronic device comprised in a Christmas ornament, which thereby associates the ornament with the subject.

The disclosed methods overcome the shortcoming of uncertainty that exists with prior art Christmas ornaments with regards to whether or not a personalized Christmas ornament that is associated with a particular person or animal is imbued with a residual presence of that person or animal. Representative physical embodiments of the methods are presented to make clear their inventive nature, hint at how they can be applied in practice, and to point out some practical and aesthetic considerations that may guide producers of personal energy Christmas ornaments.

Christmas ornaments come in every shape, design and form imaginable; personal energy Christmas ornaments are no different. What will be the common distinguishing characteristic of a personal energy Christmas ornament of any form is its association with a store of personal energy harvested from the living body of one or more persons and/or animals, hereinafter alternately referred to as the “subject” of a personal energy Christmas ornament. This harvested energy is referred to herein as “personal energy.” The Christmas ornament can itself comprise an energy storage device that is charged with the person(s) and/or animal(s)' harvested personal energy; or, it can be associated in a variety of ways with another item, an accessory, that comprises the same. The energy storage device, so charged, will be the power source for an electronic device comprised either by the personal energy Christmas ornament or by another item accessory to the personal energy Christmas ornament.

The present disclosure proposes two general approaches to harvesting and creating a store of the harvested energy that is associated with a personal energy Christmas ornament. One approach teaches external harvesting and charging apparatus, while a second approach teaches comprising one or both of these components in a personal energy Christmas ornament itself, in an item accessory to it, or in some combination thereof. These approaches to personal energy harvesting and the configurations of storage and evincing electronic devices are exemplified in four representative embodiments herein.

In a first representative embodiment a Christmas ornament is made of a powered card of about credit card form. The powered card, decorated with Christmas imagery and indicia, features light emitting diodes that are powered by thin-film batteries that have been charged with the harvested personal energy of one or more human and/or animal subjects. A specialized wearable energy harvesting and charging station for charging the powered card is proposed as well.

A second representative embodiment creates a Christmas streamer ornament from a flexible electroluminescent (EL) tape mounted on a fabric and sealed with a writeable lamina surface. The streamer ornament, comprising thin-film batteries and thermoelectric generators (TEG), is worn around the neck of a user, which enables the TEG's to harvest the thermal energy of the wearer's body warmth and charge the thin-film batteries that power the streamer ornament's EL tape.

In a third representative embodiment, a translucent cube-shaped Christmas ornament with themed artwork and indicia is illuminated from within by one or more LED's which are powered by a proposed thin-film battery structure mounted on a plastic celluloid card. The “battery card,” also comprises its own energy harvesting device and thus is able to harvest and charge the battery card's thin-film batteries with the subject's personal energy.

And in a fourth representative embodiment, a Christmas tree topper ornament features an electroluminescent (EL) sheet and a single LED that are powered by a battery pack comprising a large number of thin-film batteries. The battery pack is charged with the merged, collective harvested personal energy of several or many subjects by means of a specialized charging station that transfers electrical power from a number of self-charging thin-film battery structures to the battery pack.

Existing technology offers several ways and concomitant devices for harvesting energy from human or animal sources. It is not the purpose of the present invention to teach or disclose an energy harvesting method or device, but rather how to utilize these for the purposes of the present invention. The thermal energy of a person or animal's body heat is the preferred source of energy harvested for a personal energy Christmas ornament. Human beings associate the warmth of the body with the life and spirit of a living person or animal, and sharing this warmth is a bonding experience. Present technology suggests the use of a thermoelectric generator (TEG) to harvest body heat. Thus, in each of the four proposed representative embodiments, the representative energy harvesting device is one or more thermoelectric generators. Those skilled in the art will recognize that other types of energy harvesting devices could be used where TEG's are used in the following representative embodiments.

A single personal energy Christmas ornament can be associated with the personal energy of one or more persons and/or animals. The subject or subjects' personal energy can be harvested firsthand or secondhand. A personal energy Christmas ornament can have one or more electronic devices, with one, some or all powered by the subject or subjects' harvested personal energy in a variety of arrangements.

The length of time an electrical energy storage device can retain a charge, as well as its suitability to energy harvesting applications are important factors to take into account when considering its inclusion in a personal energy Christmas ornament. A particular thin-film battery with exceptional specifications in these regards is identified and stated as preferred herein.

Other arrangements, methods, features and advantages of the invention will be, or will become apparent to one with skill in the art viewing the following figures and reading their detailed descriptions. It is intended that any such additional arrangement, method, feature and/or advantage be included within this description, be within the scope of the invention, and be protected by the following claims.

### BRIEF DESCRIPTION OF THE SEVERAL DRAWINGS

The following drawings are intended to make clear the present invention. The components in the figures are not necessarily to scale, emphasis is instead placed on illustrating the principles of the invention.

FIG. 1 is a front perspective of a first representative embodiment, a Christmas ornament in the form of a powered card.

FIG. 2 is a rear perspective of powered card Christmas ornament of FIG. 1.

FIGS. 3 and 4 illustrate a simplified operating circuit and component design of the powered card Christmas ornament of FIG. 1.

FIGS. 5 and 6 illustrate a wearable charging station in the form of a waistband.

FIG. 7 illustrates the typical structure of a thermoelectric generator (TEG).

FIG. 8 illustrates the action of placing the powered card Christmas ornament of FIG. 1 into the wearable charging station of FIGS. 5 and 6.

FIG. 9 schematically illustrates a simplified operating circuit and component design of the charging station shown in FIGS. 5 and 6.

FIG. 10 is a front perspective view of a second representative embodiment, a self-powered illuminated Christmas streamer ornament.

FIG. 11 is a cutaway side view of the illuminated Christmas streamer ornament of FIG. 10.

FIG. 12 is a rear perspective view of the illuminated Christmas streamer ornament of FIG. 10.

FIG. 13 schematically illustrates a simplified operating circuit and component design of the illuminating Christmas streamer ornament of FIG. 10.

FIG. 14 illustrates a energy harvesting and battery charging apparatus and an alternative configuration for the illuminating Christmas streamer ornament of FIG. 10.

FIG. 15 is a front perspective view of a cube-shaped illuminated Christmas ornament.

FIG. 16 is a rear perspective view of the cube-shaped illuminated Christmas ornament of FIG. 15.

FIG. 17 is a front perspective view of a self-charging thin-film battery structure of about credit card form factor.

FIG. 18 is a rear perspective view of the thin-film battery structure of FIG. 17.

FIG. 19 illustrates the action of the thin-film battery structure of FIGS. 17 and 18 being inserted into the illuminated Christmas ornament of FIG. 15.

FIG. 20 illustrates a system for powering an illuminated Christmas tree topper ornament with energy harvested from a person or animal.

FIG. 21 is a front perspective view of a specialized charging station used in the system of FIG. 20.

FIG. 22 is a perspective view of a battery pack used in the system of FIG. 20 and includes an inset illustration of thin-film batteries comprised by the battery pack.

FIG. 23 is a detailed illustration of the front of the illuminated Christmas tree topper ornament of the system illustrated in FIG. 20.

### DETAILED DESCRIPTION OF THE INVENTION AND REPRESENTATIVE EMBODIMENTS

For efficiency, the pronouns “their”, “they” and “them” are sometimes used in this disclosure as gender-neutral pronouns referring to both singular or plural persons, as is common in English usage today. The term “personal energy” is used herein to refer to energy that is naturally translated by the living body of a human being or animal; “harvested personal energy” is such energy collected by an energy harvesting device. While the term “energy harvesting” has come for many to refer to today's cutting edge technology for micro-energy, in this disclosure the definition of “energy harvesting device” shall include a mechanical electric generator that is manually operated by a person or animal, the definition of “personal energy” above given shall encompass the energy expended thereby, and when harvested, this energy shall be understood to be “harvested personal energy” as well.

As used herein, the term “personalize” refers to the action of adding to an object something which facilitates or furthers the object being distinctly associated with a particular person or persons, and/or animal(s). As used herein, the term “subject” refers to the person or animal associated with a Christmas ornament. The terms “human being(s)” and “person” or “people” are used alternately herein with the same meaning. The term “and/or” as used in this disclosure includes any and all combinations of one or more of the items associated or listed. The singular forms “a,” “an” and “the” are intended to include plural forms as well, unless clearly defined or indicated otherwise in the context they appear. When the terms “comprise(s),” “comprised” and/or “comprising” are used, they specify the presence of a stated component, item, feature, etc., but do not preclude the presence or addition of other features, components, items, and etcetera. Terms used in this disclosure are intended to have meanings consistent with their meanings in the context of the art and should not be contracted, expanded or construed to have different meanings or interpretations unless they are defined in such a way in this disclosure. It will be understood that different orientations are possible in addition to the orientations depicted in the figures.

The creation of a personal energy Christmas ornament will generally happen in two phases: provision and personalization. A Christmas ornament product that is structured and outfitted to serve as a personal energy Christmas ornament is provided; then, it is personalized and thus enhanced with the harvested personal energy of one or more persons and/or animals. Generally, separate parties, a provider and a user, will carry out these tasks. Likely, the provider will be a person or business that produces Christmas ornaments, and the user a customer who purchases a personal energy Christmas ornament from the provider, directly or indirectly, and then personalizes and thus enhances it with their own or a significant other's harvested personal energy. The user may or may not him- or herself be the subject of the personal energy Christmas ornament. In certain circumstances, the provider could both provide a personal energy Christmas ornament and personalize it with the personal energy of one or more persons and/or animals. For example, a provider may be tasked with creating or providing a special personal energy Christmas ornament and additionally with the tasks of harvesting energy from the subject(s), and adding the stored harvested energy to the ornament before delivering it.

The special intrinsic worth of a personal energy Christmas ornament lies with the store of personal energy it holds, uses and/or is otherwise associated with. A personal energy Christmas ornament retains this special worth for as long as the store of personal energy remains. Therefore, charged shelf life, i.e. how long an energy storage device can maintain an operational charge when stored and not used, should be a fundamental consideration when selecting an energy storage device to be used with a personal energy Christmas ornament.

The preferred energy storage device for the present invention is a rechargeable micro-energy cell (MEC) type of thin-film battery produced by Infinite Power Solutions (IPS) of Littleton, Colo. in USA and marketed under the brand name THINERGY®. These batteries are designed specifically for energy harvesting applications and have an exceptional estimated charged shelf life of twenty or more years. Furthermore, they have an exceptional depth of discharge (DOD) of 99% at full discharge. By fully discharging a THINERGY® MEC before recharging it with energy harvested from a person or animal subject, the MEC can, for all intents and purposes, be charged exclusively with the subject's harvested personal energy, a characteristic that would enhance even further the intrinsic worth of a personal energy Christmas ornament. Hereinafter, the term “micro energy cell(s)” and the acronym “MEC” will be used to refer to these preferred thin-film batteries in this disclosure. It should be noted that micro-energy cells at their present state of development require a power management integrated circuit (PMIC). As such, a PMIC is part of the circuitry where needed in the representative embodiments given in this disclosure as well.

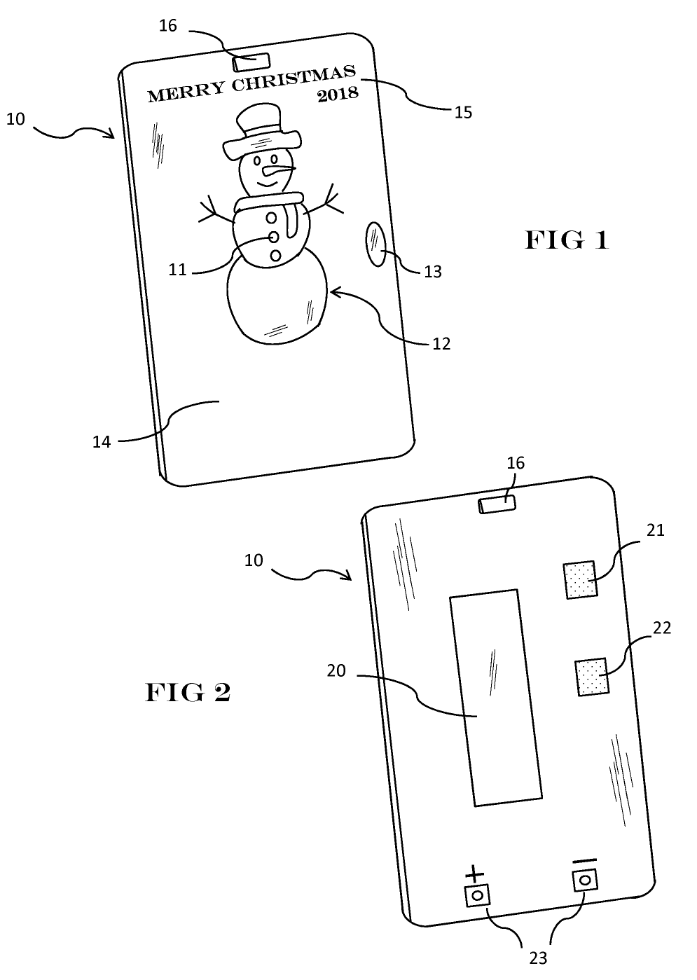

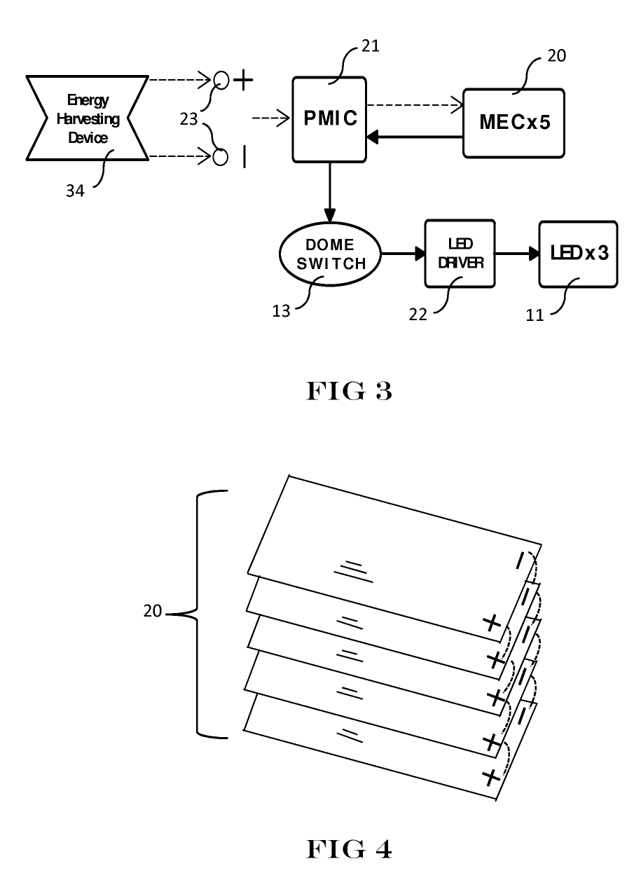

The first representative embodiment of the present invention is a Christmas ornament in the form of a powered card ornament 10, illustrated in FIGS. 1-4. A “powered card” is a card that comprises at least an energy storage device and an electronic feature powered by the energy storage device. The powered card ornament 10, which hereinafter may alternately be referred to as simply “the ornament 10,” is built on a celluloid plastic card substrate of about credit card form factor and comprises three LED's 11, five micro-energy cells (MEC) 20 stacked in parallel configuration, as illustrated in detail in FIG. 4, a power management integrated circuit (PMIC) 21, an LED driver integrated circuit 22, and two contact posts 23. On the front of the ornament 10, indicia 15 reading “Merry Christmas 2018” indicates the year and the ornament's 10 Christmas purpose, and an illustrated snowman 12 decorates the ornament 10 with a common Christmas motif. The three LED's 11 are positioned such that they appear as three buttons on the illustrated snowman's 12 torso section.

When a dome switch 13 is pressed, the three LED's 11 are illuminated via the LED driver integrated circuit 22 with electrical power provided by the stacked MEC's 20, which can be charged via the contact posts 23 with energy harvested from the body of one or more person's and/or animals by any suitable energy harvesting device 34. An intervening power management integrated circuit (PMIC) 21 manages both the charging and the discharging of the MEC's 20. A user can initially or further personalize the ornament 10 by hand, using a pen or marker for example, to add a greeting, their name or other information to a blank “writeable” area 14. Charged and marked accordingly, the powered card ornament 10 can be hung from a Christmas tree branch or other structure that is part of a Christmas decoration with a ribbon, string or hook passed through a loophole 16. The powered card ornament's 10 circuitry could include a timer that controlled how long the LED's 11 remained illuminated when the dome switch 13 was pressed, a feature that could help conserve the ornament's 10 limited store of the subject's harvested personal energy. Because the MEC's 20 are rechargeable, once their store of harvested personal energy is used up, the ornament's 10 drained MEC's 20 can be recharged via the suitable harvesting device 34.

The powered card ornament 10 could be charged directly, using wires from a selected harvesting apparatus and so-called “banana clips” connected to the contact posts 23. However, this would not be a practical, user-friendly solution. An apparatus designed specifically for charging the powered card ornament 10 with the electrical output of an energy harvesting device would be more practical. Ideal would be an apparatus that could be worn so that the subject (i.e. the person or animal for or by whom the ornament 10 is personalized) could be free to go about their regular activities while their personal energy was harvested passively and used to charge a powered card ornament 10.

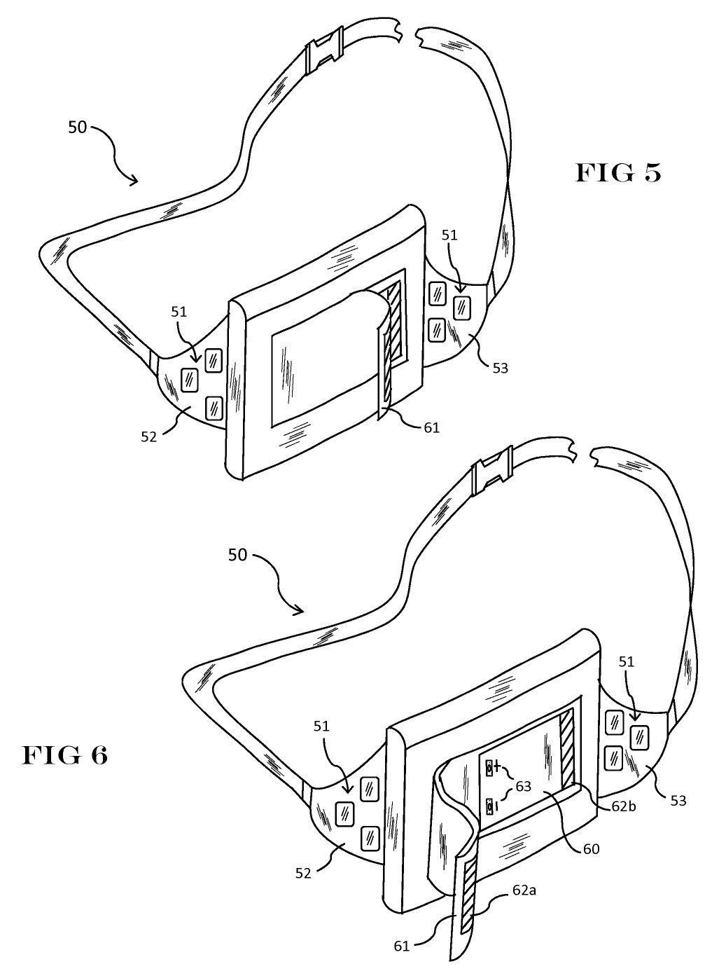

To such ends, proposed is a waistband harvesting/charging station 50, illustrated in FIGS. 5-9, that wraps around the waist of a person or around a part of the body of an animal, where it harvests the thermal energy of the person or animal's body heat by means of six thermoelectric generators (TEG's) 51 that are capable of harvesting thermal energy from the body heat of a living person or animal, a pet dog for example, and converting it to an output of electrical power. Three of the harvesting/charging station's 50 six TEG's 51 are mounted in the charging station's 50 left side panel 52 and three are mounted in the harvesting/charging station's 50 right side panel 53. The six TEG's 51 are electrically connected in a parallel stacking configuration. Preferably, the six TEG's 51 are specialized to harvesting thermal energy from the warm body of a person or animal; one particular such specialized thermoelectric generator is the flexible, wearable ThermoLife® TEG module made by a division of Perpetua Power Source Technologies Inc. of USA.

The harvesting/charging station 50 further comprises a charging apparatus 60 covered by a flap 61 that is held in place over the charging apparatus 60 by the two complementing sides of a Velcro strip 62a and 62b. The charging apparatus 60 is electrically connected to the six TEG's 51 and is designed to charge an inserted powered card ornament 10 with electrical power generated by the combined output of the electrically stacked six TEG's 51 when the waistband harvesting/charging station 50 is worn by a person or animal.

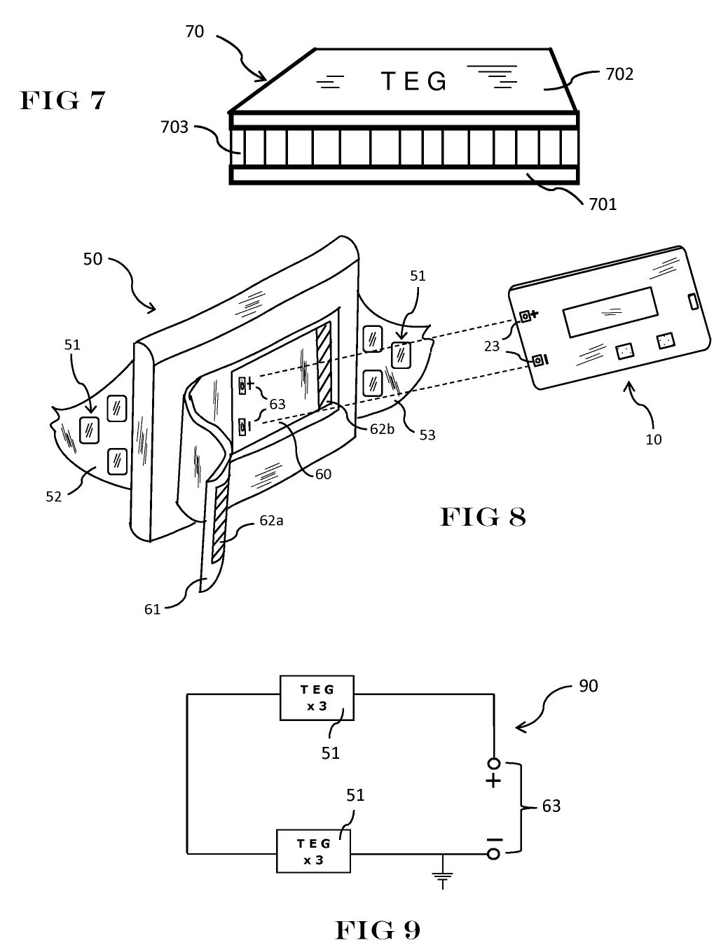

Thermoelectric generators exploit the Seebeck effect, a phenomenon by which an electric current is produced when there exists a temperature differences between two dissimilar metals in a circuit; in short, thermal energy is converted to electrical power. FIG. 7 illustrates the typical structure of a thermoelectric generator (TEG) 70. The TEG 70 has two planar surfaces, a “hot side” 701 and a “cold side” 702, which sandwich a large number of thermopiles 703. To generate electricity, the hot side 701 is exposed to a warm surface or warm ambient environment while the cold side 702 is exposed to a surface or ambient environment that is significantly cooler than that to which the hot side 701 is exposed. To most effectively harvest energy from a human or animal source, both the hot side 701 and the cold side 702 of a thermoelectric generator should be as fully exposed, i.e. not covered by any material or substance, as practically possible.

Accordingly, the harvesting/charging station's 50 comprised six TEG's 51 are mounted such that their hot sides are exposed at the rear of the harvesting/charging station 50 and their cold sides are exposed at the front of the harvesting/charging station 50. Thus, when a person or animal wears the harvesting/charging station 50, the hot sides of the six TEG's 51 are placed in close proximity to their warm body while the cold sides of the TEG's 51 are left exposed to the ambient temperature of their environment, which it is assumed will be cooler than the temperature of the wearer's body. For situations where the temperature of the wearer's ambient environment can be expected to be warmer than their body temperature, the hot side/cold side configuration can be reversed. Certain specialized thermoelectric generators have planar surfaces that serve as either hot or cold sides depending on the conditions they are exposed to, and thus can adapt to any temperature difference conditions to generate electrical power.

As illustrated in FIG. 8, with the flap 51 opened, the powered card ornament 10 can be inserted into the charging apparatus 60, where the ornament's 10 contact posts 23 come into contact with corresponding contact posts 63 disposed inside the charging apparatus 60, electrically connecting the circuitry of the powered card ornament 10 with the circuitry 90 disposed inside the harvesting/charging station 50, illustrated in FIG. 9. The intended subject of the powered card ornament 10 then charges the ornament's 10 stacked MEC's 20 with their harvested personal energy by wearing the waistband harvesting/charging station 50 for a period established by the ornament's 10 manufacturer's guidelines. The electrical power output of the six TEG's 51 is conditioned by the ornament's 10 comprised PMIC 21, which delivers the conditioned electrical power to and manages the charging of the MEC's 20. In more sophisticated designs, the charging station 50 could comprise a charge monitor or so-called “fuel gauge” that could indicate to the wearer when an inserted powered card ornament 10 is fully or sufficiently charged.

The powered card ornament 10 is a representative embodiment only. Such an ornament could be of any shape or design, and of any material. For example, instead of being of credit card form factor, the powered card ornament 10 could be in the shape of a star, a tree, a snowman, or some other common Christmas design; and instead of being built on a celluloid plastic card, the ornament 10 could perhaps be built on paper card stock or molded foam. Because the celluloid plastic card of credit card form factor is a standard card (ISO 7810) that powered cards are commonly built on, it can be expected that building a personal energy Christmas ornament on such a card would be a low cost option.

If the back of the powered card ornament 10 were covered with a writeable lamina, the user could have an additional area to add a personal greeting to the ornament 10. The ornament 10 could come with accessories that would facilitate the ornament 10 being mailed or given to others, such as a plastic protective sleeve and an envelope. Many copies of a powered card ornament 10 could be produced; or, for a very special event, only a few, perhaps only one. If the powered card ornament 10 were additionally configured so that it could output energy through its contact posts 23, it could be used to power a separate electronic device, thereby evincing the subject's harvested energy via the separate device instead of or in addition to the ornament's 10 own evincing electronic device. This separate electronic device and a powered card ornament 10 so configured could be complementing parts of a Christmas ornament product or system.

The manner in which the subject's personal energy is harvested is limited only by practicality. For example, the harvesting/charging station 50 could employ piezoelectric or Faraday devices, among other options, that harvest the kinetic energy of a person or animal wearing the charging station 50. In an alternative approach, the powered card ornament 10 could itself be configured to comprise an energy harvesting device, such as a thermoelectric, piezoelectric or Faraday generator, in which case there would be no need for a separate harvesting and charging apparatus, as the powered card ornament 10 could itself be worn or interacted with by the subject to harvest their personal energy.

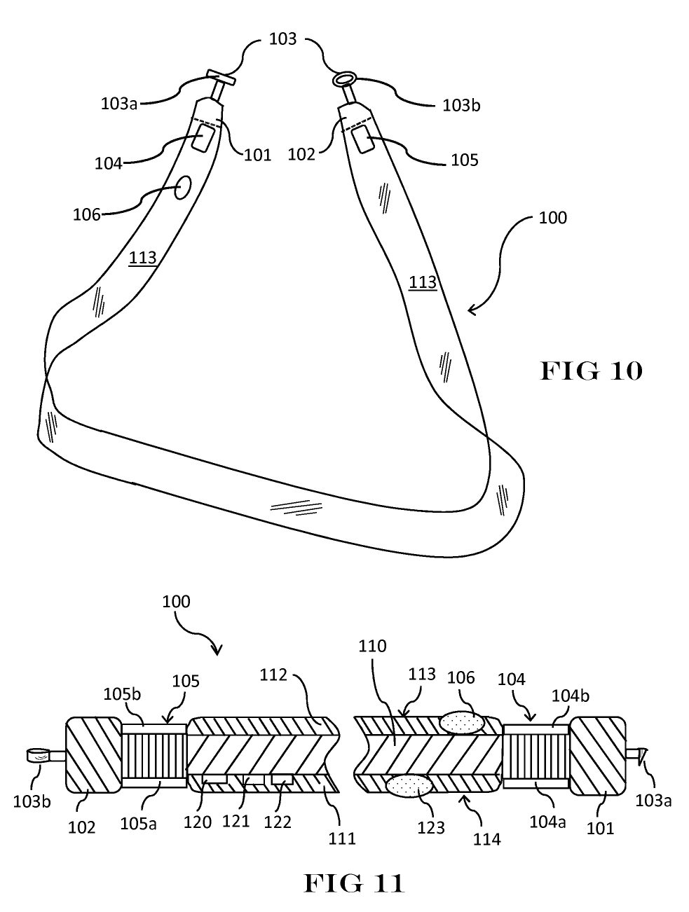

A second representative embodiment, an illuminated Christmas streamer ornament 100, is illustrated in FIGS. 10-13. The illuminated Christmas streamer ornament 100 is outfitted to harvest and store personal energy from the body of a person or animal and use the energy to power and illuminate itself. For efficiency, the illuminated Christmas streamer ornament 100 may hereinafter be alternately referred to as simply “the streamer 100.” A user can mark the front surface 113 of the streamer 100 to personalize it further with their own Christmas greeting, their name, etc. The streamer 100 can be hung on a Christmas tree or at a space that is decorated for Christmas, such as a window, fireplace, wall, banister, threshold, etc.

Except for a first fabric anchor 101 at one end of the streamer and a second fabric anchor 102 at the other end of the streamer, the illuminated Christmas streamer ornament 100, about 30 inches long and 1.5 inches wide, is made of a flexible electroluminescent (EL) tape 110, such as the Light Tape® brand made by Electro-LuminX Lighting Corporation of USA. The EL tape 110 is mounted on a flexible fabric substrate 111, which covers the rear surface 114 of the EL tape 110. The fabric substrate 111 could be plain and single colored or of multiple colors; it could have Christmas themed indicia and artwork printed on it. The front surface 113 of the EL tape 110 is laminated with a flexible, writeable matte lamina 112. An example of such a lamina product is the Convex® lamina brand produced by Graphic Marking Systems of USA; or, the Write-O® brand made by the same company. The lamina 112 is preferably plain so that a user can add their own greetings and/or drawings of Christmas images to the streamer 100; alternatively, the lamina 112 could have Christmas artwork and indicia printed on it. If the latter, then it is preferred that the some space is left blank so that a user can still personalize the streamer 100 with their own markings.

The EL tape 110, fabric substrate 111 and lamina 112 are similarly flexible so that the streamer 100 as a whole is sufficiently flexible to wrap around and suspend from a person's neck and shoulders like a ribbon lanyard commonly worn in the workplace to display an employee's name card or company credentials; or, to wrap around an animal's body. A coupled clasp 103, with a male clasp part 103a attached to the first fabric anchor 101 and a female clasp part 103b attached to the second fabric anchor 102, allows a user to join the two ends of the streamer 100 so that it can be worn as a lanyard when the coupled clasp 103 is engaged at the nape of the wearer's neck. The male clasp part 103a and the female clasp part 103b can also facilitate suspending the streamer 100 from a Christmas tree branch or from other structures where streamers and festoons are used as Christmas holiday adornments.

The illuminated Christmas streamer 100 is outfitted with two thermoelectric generators: a first TEG 104 is mounted at one end of the streamer 100 near the first fabric anchor 101, and a second TEG 105 is mounted at the other end near the second fabric anchor 102. As is illustrated in FIG. 11, the first TEG 104 is firmly mounted in a space between the first anchor 101 and the rest of the streamer 100, such that its hot side 104a is exposed at the rear surface 114 of the streamer 100, and its cold side 104b is exposed at the front surface 113. The second TEG 105 is similarly fitted, its hot side 105a and cold side 105b similarly exposed. Thus configured, when the coupled clasp 103 is engaged at the nape of the neck of a person wearing the streamer 100 with the fabric substrate 111 of the rear surface 114 against their body, the hot side 104a of the first TEG 104 and the hot side 105a of the second TEG 105 come in contact or near contact with the warm skin surface of the back of the wearer's neck, while the cold side 104b of the first TEG 104 and cold side 105b of the second TEG 105 are more or less exposed to the usually cooler ambient temperatures of the wearer's environment (depending on the length of the wearer's hair and the degree that clothing covers the nape of their neck). With some adjustments, the streamer 100 may be wrapped around the body of an animal to achieve the same; however, ideally a maker of the streamer 100 would produce alternative designs tailored to various pet body shapes and sizes.

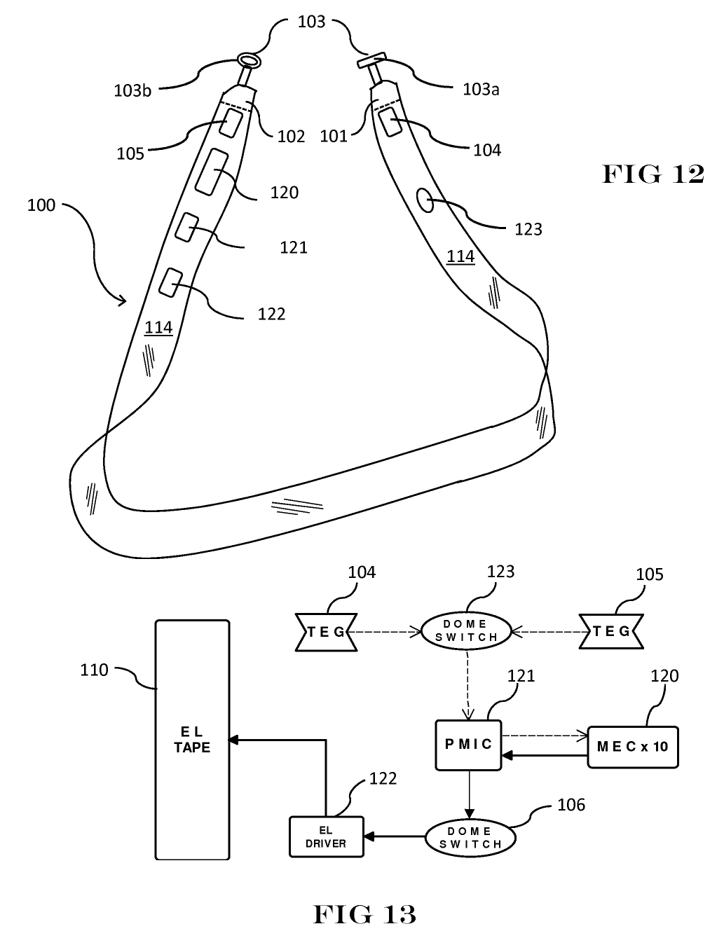

As illustrated by FIGS. 12 and 13, the first TEG 104 and second TEG 105 convert the thermal heat collected from the warm body of the person wearing the streamer 100 to electrical power, which they deliver to an intervening power management integrated circuit (PMIC) 121, via a dome switch 123, which is pressed to enable or disable the flow of electrical power from the first TEG 104 and second TEG 105 to the PMIC 121, which conditions the electrical power and uses it to charge a stack of ten micro-energy cells (MEC) 120, stacked in parallel configuration and mounted between the fabric substrate 111 and the EL tape 110, near the second TEG 105. When a dome switch 106 is pressed, the MEC's 120 power the EL tape 110 via the PMIC 121 and an EL driver 122, which conditions the voltage to make it suitable for illuminating the EL tape 110. The length of time the user needs to wear the streamer 100 in order to fully or sufficiently charge the MEC's 120 can be per manufacturer's guidelines; in more sophisticated designs, a battery charge monitor or fuel gauge capable of signaling at least when the MEC's 120 are fully or sufficiently charged could be included in the streamer's 100 circuitry.

The dome switch 123 is an important control measure: since a thermoelectric generator will harvest energy whenever a temperature difference exists between its hot and cold sides, there needs to be a way to control the flow of electrical power from the first TEG 104 and second TEG 105 to the MEC's 120. The control provided by the dome switch 123 helps ensure that the MEC's 120 are charged only when a user intends to charge them and thus charged with the harvested personal energy of the streamer's 100 intended subject only.

After wearing the illuminated Christmas streamer 100 and charging its MEC's 120 for a sufficient period, the wearer presses the dome switch 123 once more to disable the harvesting/charging functions, disengages the coupled clasp 103, and takes off the streamer 100, which is now ready to be added to a Christmas tree or other Christmas decoration as a personal energy Christmas ornament. To power the illuminated Christmas streamer's 100 comprised EL tape 110, the user presses the dome switch 106. In the simple design disclosed here, the EL tape 110 remains illuminated until the dome switch 106 is pressed again to turn it off; in a more sophisticated design, a timer circuit could intervene and the EL tape 110 could remain illuminated for a set period before being automatically turned off, remaining off until a user pressed the dome switch 106 once more to illuminate the EL tape 110 again. The latter option could extend the useful per charge life of the MEC's 120.

When the MEC's 120 are drained, a user can simply repeat the wearing/harvesting/charging steps to recharge them. Some users may want to ensure that theirs is the only harvested personal energy ever stored and evinced by the illuminated Christmas streamer ornament 100. To satisfy this desire, the dome switch 123 could alternatively be a breakaway or damageable type of switch that a user could remove or break once he or she has completed the harvesting/charging steps, thereby permanently preventing the streamer's 100 stacked MEC's 120 from ever being charged with any other person or animal's harvested personal energy subsequently.

If manufactured as described and illustrated above, each and every illuminated Christmas streamer 100 would comprise two thermoelectric generators (TEG), a factor that could significantly impact the retail price of the streamer 100. Besides the cost of the TEG's themselves, there would be costs associated with including them in the manufacturing process and with packaging elements necessary to protect the TEG's from damage in shipping and handling once they are part of an illuminated Christmas streamer ornament 100. Thus, a maker may seek an alternative whereby one or more TEG's, or another type of harvesting device, are comprised separately in a reusable, wearable energy harvesting charging station that the illuminated Christmas streamer ornament 100 could electrically connect to and be charged by.

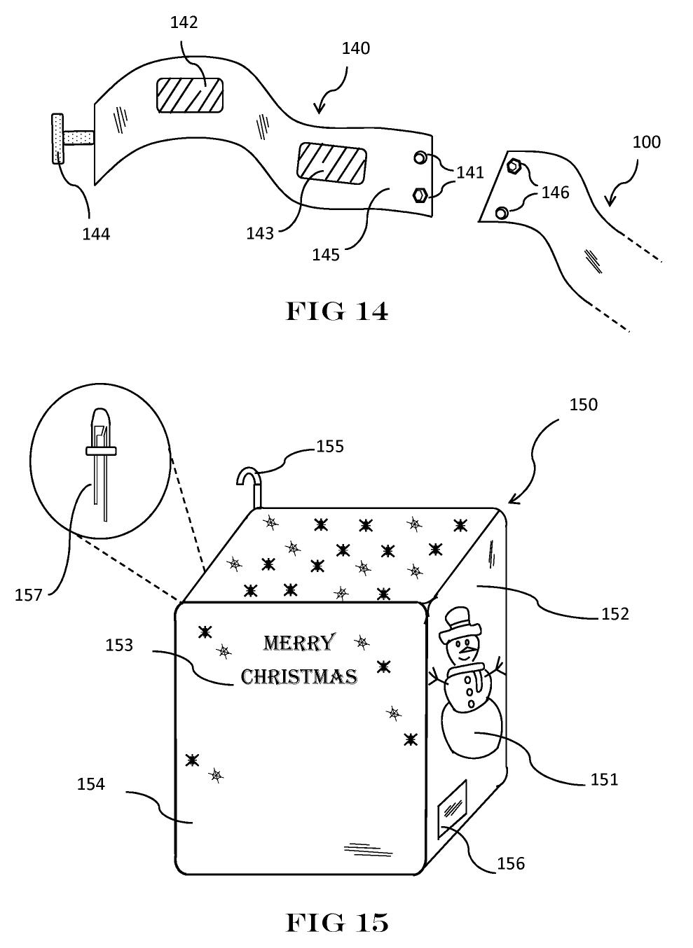

A proposed suitable such solution is illustrated in FIG. 14. A specialized energy harvesting/charging station 140 comprises two thermoelectric generators (TEG), a first TEG 142 and a second TEG 143, a pair of contact posts 141 of the type commonly found on nine-volt batteries, and a male clasp part 144 of the same type as the streamer's 100 previously described male clasp part 103a and thus a mate to the streamer's 100 female clasp part 103b. The components are mounted in or on a flexible fabric substrate 145. The first TEG 142 and the second TEG 143 are each mounted in a space cut out from the fabric substrate 145 such that each is exposed at the front and rear of the energy harvesting/charging station 140. The first TEG 142 and the second TEG 143 are stacked and connected electrically to the contact posts 141.

The configuration of the illuminated Christmas streamer 100 could be altered to make use of this energy harvesting/charging station 140 to charge the streamer's 100 comprised MEC's 120. FIG. 14 shows that instead of comprising the male clasp part 103a of the coupled clasp 103 as previously described, the one end of the streamer 100 could alternatively comprise corresponding contact posts 146 that would make it possible for the streamer 100 to be physically and electrically connected to the energy harvesting/charging station 140. In this case, the streamer 100 would not need to comprise its own harvesting devices, i.e. the first TEG 104 and the second TEG 105 of the configuration shown in FIGS. 10-13, nor the control dome switch 123, as the streamer's MEC's 120 would be charged only when the user connects the streamer's 100 contact posts 146 of this alternative configuration to the harvesting/charging station's 140 contact posts 141.

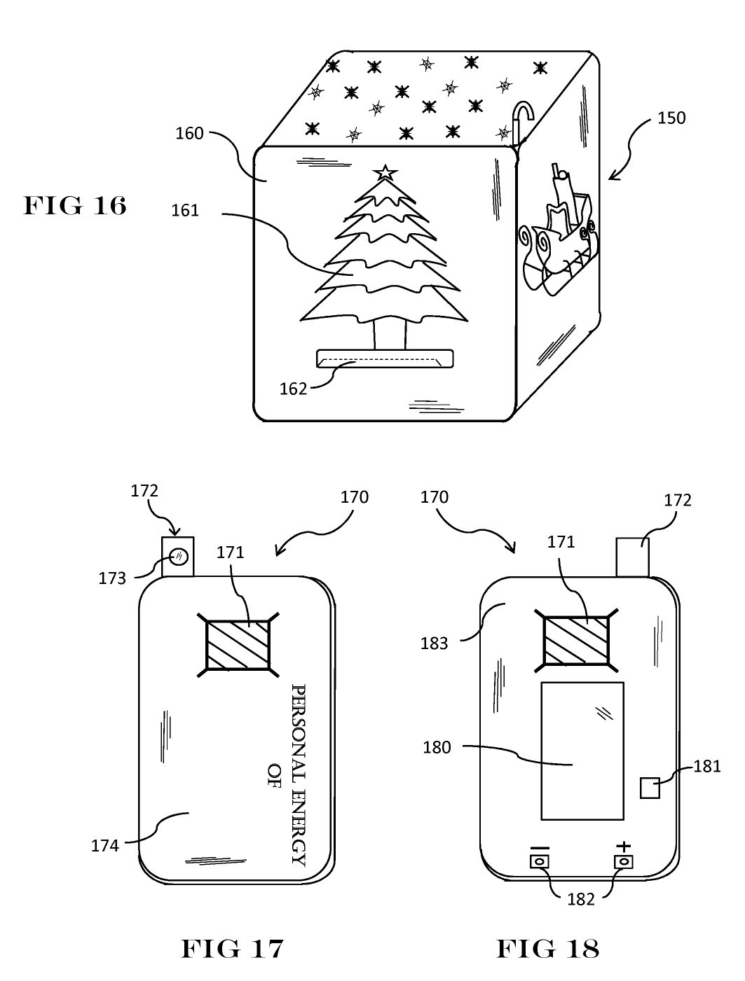

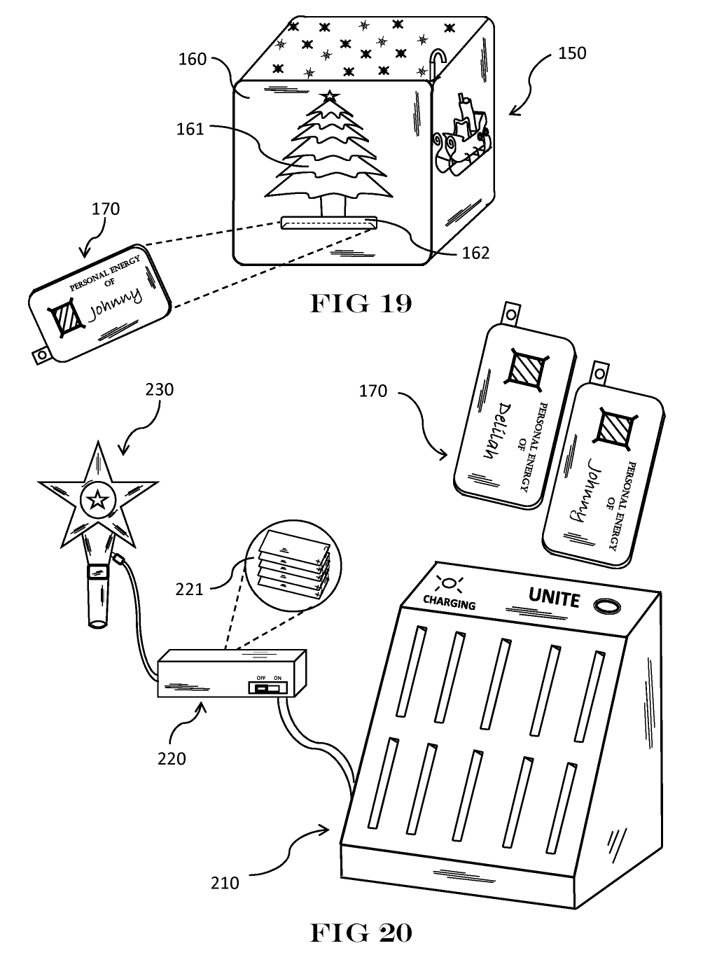

A third representative embodiment is illustrated in FIGS. 15-19. A battery-powered illuminated Christmas ornament 150 of a cube shape has typical Christmas design elements printed on each of its surfaces, such as a snowman illustration 151 on the right surface 152, and a “Merry Christmas” greeting indicia 153 on the front surface 154, which is a writeable surface where a user may add their own greeting, their name, etc. by hand with a pen, a marker, or such to initially or further personalize the ornament 150. On the rear surface 160, just below an illustration of a Christmas tree 161, there is a battery slot 162, where a custom battery structure, a self-charging battery card 170, can be inserted to power an LED 157 disposed inside the ornament 150, when a user touches the actuating surface of a touch switch 156 disposed on the right surface 152. A hook hanger 155 at one upper corner facilitates hanging the illuminated cube ornament 150 from a Christmas tree branch or from a part of some other Christmas decoration. The cube ornament 150 could alternatively be placed and displayed on a surface, such as a mantle, a desk, a countertop, etc.

The custom self-charging battery card 170 comprises a single thermoelectric generator (TEG) 171 that is mounted in a window cut out from the body of the battery card 170 such that the TEG 171 is exposed on each side of the battery card 170. When a user presses a dome switch 173, disposed on a detachable tab 172, the harvesting and charging functions of the battery card 170 are enabled and electrical power generated by the TEG 171 is delivered to a power management integrated circuit (PMIC) 181, which conditions the electrical power before using it to charge five micro-energy cells (MEC) 180 that are stacked in parallel configuration and mounted on the rear surface 183 of the battery card 170. After pressing the dome switch 173, the user simply keeps the battery card 170 near their body, where the TEG 171 can harvest the thermal energy of their body's warmth to generate electrical power. For example, the battery card 170 could be kept in a shirt pocket, where one side of the TEG 171 would be exposed to the warmth of the user's body and the other side to the usually cooler ambient temperatures of their surroundings. Or, as another example, a lanyard with a mesh pocket could allow the user to wear the self-charging battery card 170 as they would a lanyard and name card, positioning the battery card 170 such that its one side is exposed to the warmth of the user's chest or abdomen and its other side to their ambient environment.

After charging the battery card 170, the user presses the dome switch 173 once more to disable the harvesting and charging functions of the battery card 170. The user can add their name to the battery card 170's writeable front surface 174. When ready to use the battery card 170, the user inserts the battery card 170 into the ornament's 150 battery slot 162 to power the single LED 157, which illuminates the ornament 150 from within when the touch switch 156 is touched. The battery card 170 can be recharged as needed by repeating the harvesting/charging steps. Alternatively, after charging the battery card 170, the user can choose to tear away the detachable tab 172 to permanently disable the battery card's 170 harvesting/charging functions, a feature that may appeal to some users' sentimentalities. Doing so would assure a user that the battery card 170 could not be used again and that their harvested personal energy is and will be the only energy ever stored in the battery card 170. As the preferred micro-energy cells are capable of retaining a useful charge for at least twenty years, some users may want to illuminate the ornament 150 sparingly so that a loved one's harvested personal energy, stored in the battery card 170, could be evinced by the ornament 150 at Christmas for many years after.

It is envisioned that the illuminated cube ornament 150 and the battery card 170 that powers it could be sold together or separately. If sold separately as complementing parts of a personal energy Christmas ornament product, a new sharing dynamic becomes possible. A first customer could buy an ornament 150 and a second customer could purchase a battery card 170. After charging their battery card 170 with their harvested personal energy, the second customer could then send their personalized battery card 170 to the first customer. In this way, at least a part of the sender of the battery card 170, i.e. their harvested personal energy stored in the battery card 170, could “be there for Christmas”—in spirit if not in person—when their personalized battery card 170 is used to power the first customer's ornament 150 and evince the second customer's harvested personal energy. Furthermore, the ornament 150 could have other personalization elements. For example, a user or a provider could adhere to the writeable front surface 174 a photograph of the one or more persons and/or animals associated with the ornament 150 by their store of harvested personal energy that powers the ornament's LED 157. Or, the ornament 150 could further comprise an audio and/or video component that features the same persons and/or animals.

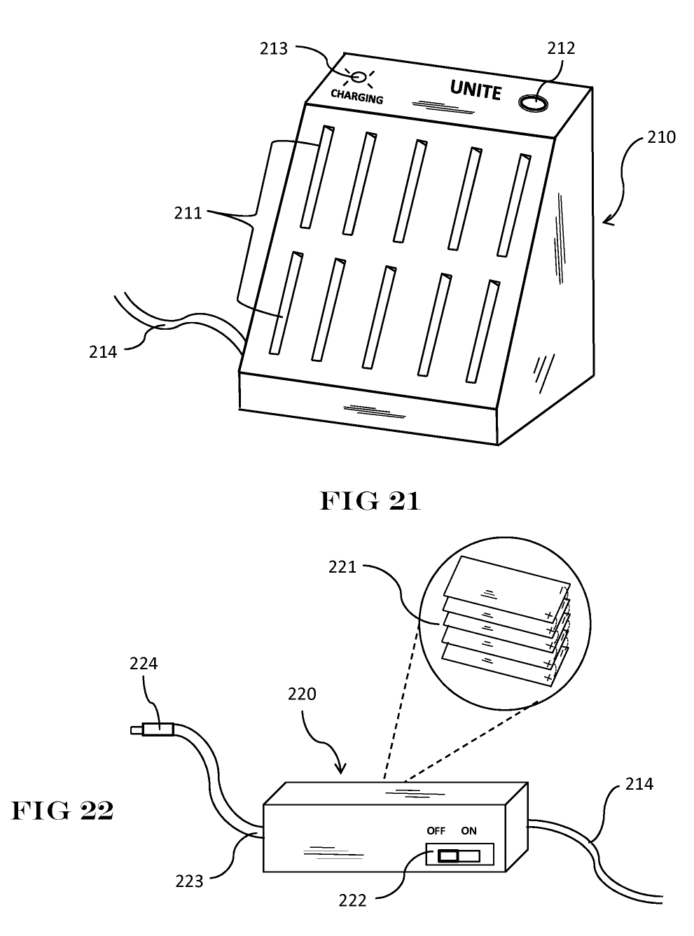

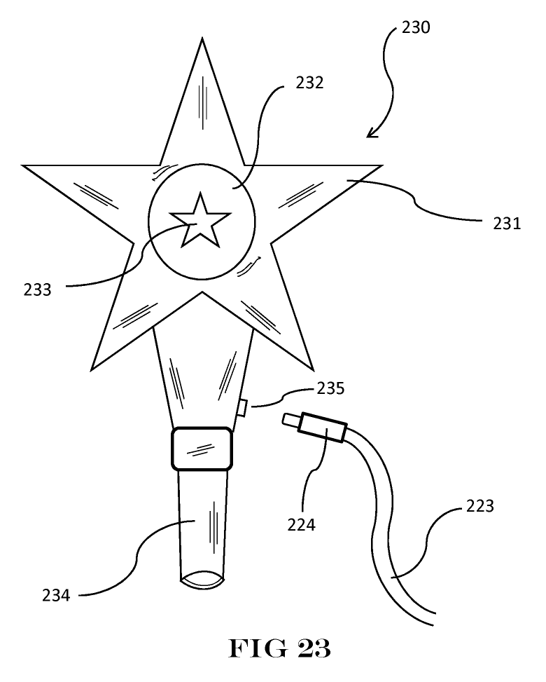

A fourth and final representative embodiment is proposed in the form of a star-shaped illuminated Christmas tree topper ornament 230. As illustrated in FIGS. 20-23, the tree topper ornament 230 is powered by an external battery pack 220 that comprises a large number of micro-energy cells (MEC) 221 stacked in parallel configuration to yield a high capacity battery pack 220. The battery pack 220 is charged by a specialized discharging/charging station 210 that can simultaneously discharge up to ten of the self-charging battery cards 170 of FIG. 17 after they've been charged with the harvested personal energy of one or many individuals, merging the individual stores of personal energy into a single, collective store in the battery pack 220. The star-shaped tree topper ornament 230 comprises a circular electroluminescent (EL) sheet 232 that fills most of the center of the ornament's 230 front surface 231. In the center of the EL sheet 232 is a single star-shaped LED lamp 233. It is envisioned that the EL sheet 232 provides a warm background light of a single or multiple automatically changing colors and the LED lamp 233 emits a constant beam of light. The EL sheet 232 and the LED lamp 233 are powered via a power jack 235 disposed along one side of the ornament's 230 mounting stem 234, where the power plug 224 of a power cord 223 extending from the battery pack 220 can be inserted.

After harvesting their own or another's personal energy with one or more of the self-charging battery cards 170, a user inserts up to ten of the battery cards 170 into the specialized discharging/charging station 210, which is electrically connected to the battery pack 220 by a removable power cord 214. Upon the user pressing a button switch 212 marked “UNITE”, the discharging/charging station 210 simultaneously discharges up to ten battery cards 170 and charges the stacked micro-energy cells (MEC) 221 that make up the battery pack 220 with the electrical power that it discharges from the battery cards 170. An LED 213 marked “CHARGING” illuminates to indicate charging of the battery pack 220 is in progress. In the case where there are more than ten battery cards 170 to process, the discharging/charging steps can be repeated until all battery cards 170 are discharged and their energy transferred to the battery pack 220. Next, the tree topper ornament 230 is mounted on the top branch of a Christmas tree and the ornament's 230 electronic features, the EL sheet 232 and the LED lamp 233, can be powered with the battery pack 220, which can be placed at the base of the tree, its power cord 223 extended to the ornament 230. The power supply can be turned on or off via a switch 222 disposed on one side of the battery pack 220. Should the battery pack 220 be drained in use, the harvesting/discharging/charging steps can be repeated with the same or new battery cards 170.

It is envisioned that a large amount of personal energy harvested from several or many persons and/or animals will power the Christmas tree topper ornament 230. In this preferred case, the energy that is stored in the battery pack 220 would represent a collective store of the personal energy of the people and/or animals whose harvested personal energy is merged there. This kind of merging of harvested personal energy may appeal to a group that shares a close emotional or collegial bond—such as a family, a class, a community, a military unit, a sports team, or the employees of a workplace. By merging their harvested personal energy, the group could express their bond and their collective “Christmas spirit” through the single Christmas tree topper ornament 230, where the light of the EL sheet 232 and the LED 233 would evince their collective personal energy. Of course, should a user desire, the energy stored in the battery pack could be that of as few as a single person and/or animal.

The Christmas tree topper ornament 230, as with any embodiment of the present invention, could have another or several other electronic devices that are powered by either additional stores of harvested personal energy or conventionally charged energy storage devices. For example, the ornament 230 could further comprise an audio component that played Christmas tunes. That component could be powered by the battery pack 220, just as the EL sheet 232 and the LED 233 are; or, it could be powered by another energy storage structure and that storage structure could also be charged with harvested personal energy sourced from the body or bodies of one or more persons and/or animals or it could be charged with energy generated by a conventional source, such as a local utility.

The Christmas tree topper ornament 230, a representative embodiment of the present invention, could have additional personalization elements, such as indicia or photography custom printed by a provider of the ornament 230, or recorded and replayable audio and/or video featuring the voice and/or images of the one or more persons and/or animals whose harvested personal energy is stored in the battery pack 220. A provider, a user, or both could add such additional personalization elements to the ornament 230.

To be truly a personal energy Christmas ornament of the present invention, the energy stored in the ornament's comprised or accessory one or more energy storage devices needs to be as purely and exclusively a store of the subject's harvested personal energy as possible. Most mass produced batteries are delivered from a manufacturer fully charged with energy produced by the manufacturer or its local utility. Thus, they need to be fully discharged at some point before the subject's personal energy is harvested. Ideally, the provider of a personal energy Christmas ornament or the provider of the abovementioned “battery cards”—or similarly purposed devices—would fully discharge the energy storage devices, used in or with their products before providing them.

However, if pre-charged energy storage devices are provided to end users, then the users will need to fully discharge the energy storage devices of their “factory charge” in a preparatory step to harvesting the subject's personal energy. In the latter case, if the preferred micro-energy cells (MEC) are the energy storage devices used, then a power management integrated circuit (PMIC) needs to be included in the circuitry of the “battery card” or other energy storage structure built with MEC's. This discharging preparatory step could be accomplished by a device similar to the above described charging or discharging stations (e.g. the harvesting/charging station 50, or the discharge/charging station 210). Or, it could be accomplished by using the energy storage device to power an electronic device, comprised in or external to the product, until the energy storage device is fully “drained” of its factory charge.

In specifying the four representative embodiments above, certain charging methods and devices, such as energy harvesting/charging station 140, are described. Other methods and devices can be employed, imagination and practicality the only limits. The subject of a personal energy Christmas ornament can harvest their own personal energy firsthand or the harvesting of their personal energy can be carried out secondhand, i.e. by a person who is not the subject. For instance, if the subject were a child, an incapacitated person, or an animal, then secondhand harvesting would likely be more practical. Also, the place or area of the body from which personal energy is harvested can be left to a user to decide. There could be areas of the body that are aesthetically, emotionally, or otherwise relevant to the subject or the recipient of a personal energy Christmas ornament that could influence harvesting site preferences.

Preferably, a personal energy Christmas ornament product will comprise or have as an accessory an item that comprises at least one electronic device that is powered by an energy storage device which has been charged with the harvested personal energy of the ornament's subject(s). A personal energy Christmas ornament product that comprises and/or has accessory to it more than one electronic device could have all of the devices powered by a single or multiple stores of the subject(s)' harvested personal energy; or, one or more of the electronic devices could be powered by the harvested personal energy while another or other electronic devices are powered by one or more separate, conventionally charged electrical energy storage device. For example, a personal energy Christmas ornament could comprise an electronic device that produces an audio output and another that features an LED light display. While a battery that is charged with the subject's harvested personal energy powered the LED light, an off-the-shelf battery that's been charged conventionally could power the audio component. This arrangement would yield a hybrid personal energy Christmas ornament product.

Moreover, the types of output of any such evincing electronic device(s) are limited only by this invention's requirement that the output evince stored harvested personal energy by directly or indirectly stimulating one or more human senses; light, heat, sound, vibration, electrical shock, a scent, animated movement, for example but not limiting, would all fulfill the requirement. It would be within the scope of the present invention if a personal energy Christmas ornament product were to additionally comprise or be associated with an accessory that comprises a space or structure to store one or more energy storage devices that have been charged with one or more persons and/or animal's harvested personal energy; this could allow a user to have a backup supply of the energy.

In collective personal energy Christmas ornament arrangements, a single comprised or accessory energy storage device could hold the merged harvested personal energy of two or more people and/or animals and power a single or several comprised or accessory electronic devices. Alternatively, a single collective personal energy Christmas ornament product could comprise or have as accessory a number of individual energy storage devices, one or more for each of a number of persons and/or animals, which together power one or more electronic devices or individually power dedicated electronic devices; or, which power a number of electronic devices in one or more of these arrangements. The individual personal energy harvested for a collective personal energy Christmas ornament could be harvested in a single process wherein a number of people and/or animals have their personal energy harvested in the same process at the same time; it could be harvested in the same process but at different times; or, it could be harvested in different processes at the same or different times. It's also envisioned that a group may form a collective display by having each member add their individual personal energy Christmas ornament to a tree or other Christmas décor, covering the Christmas tree or other space with a collective of their individually evinced harvested personal energy that expresses the group's community spirit.

For each of the four representative embodiments described above the subject of the personal energy Christmas ornament is at least implied to be a person or group of people while animal subjects are mentioned as possible. Those who have a pet or other animal that is significant in their lives may wish to create a personal energy Christmas ornament that is associated with a store or stores of the animal or animals' individual or collective harvested personal energy. Collective personal energy Christmas ornaments could be created for two or more animal subjects just as with human subjects. Furthermore, collective personal energy Christmas ornaments could have both human and animal subjects, with their personal energy stored and possibly evinced electronically in one or more of the collective arrangements described above.

Representative embodiments of the present invention have been shown, and preferences and guidance for creating the same have been given, all with the aim of providing information that can help those skilled in the relevant arts actualize the concept and teachings of the present invention. With the aforementioned depictions serving to represent and exemplify, it will be appreciated by those skilled in the art that these depictions are made by way of example only, that the invention is not limited to the particular embodiments described in this disclosure, and that various other embodiments and adaptations, changes, configurations, and substitutions may be made in any practical application of the present invention without departing from the principles and spirit of the representative embodiments nor the scope of the invention as hereinafter claimed. The present invention is not to be restricted except in light of the attached claims and their equivalents. Various modifications and changes may be made within the scope of the attached claims.

What is claimed is:

1. A method of personalizing a Christmas ornament, the method comprising in any order at least the steps of:
providing a Christmas ornament comprising an electronic device, the electronic device configured to be operatively associated with an energy storage device;
providing a chargeable energy storage device configured such that it can be operatively associated with the said electronic device;
operatively associating the chargeable energy storage device, directly or indirectly, with an energy harvesting device, the energy harvesting device capable of harvesting energy from the living body of a human being or animal;
charging the chargeable energy storage device with electrical power generated by the energy harvesting device, wherein the energy harvesting device generates said electrical power by harvesting energy from the living body or bodies of one or more human beings and/or animals and converting said energy to said electrical power;
operatively associating the chargeable energy storage device, directly or indirectly, with the electronic device;
adding one or more personalization elements to the said Christmas ornament, the one or more personalization elements identifying and associating with the Christmas ornament one or more persons and/or animals; and
powering the electronic device directly or indirectly with the chargeable energy storage device.

2. The method of claim 1, wherein the step of adding one or more personalization elements can be omitted.

3. The method of claim 1, wherein some of the steps are accomplished by one or more parties while the other step or steps are accomplished by another party or other parties, or wherein all of the steps are carried out solely by one party.

4. The method of claim 1, wherein the one or more persons and/or animals identified and associated with the Christmas ornament by the step of adding personalization elements to the Christmas ornament are at least one of the same one or more persons and/or animals from whose living body or bodies energy is harvested by the energy harvesting device.

5. The method of claim 1, wherein the electronic device, when powered, produces an output that stimulates one or more of the human senses.

6. The method of claim 1, wherein both the energy storage device and the energy harvesting device are separate and external to the Christmas ornament.

7. The method of claim 1, wherein the Christmas ornament further comprises the chargeable energy storage device while the energy harvesting device is separate and external to the Christmas ornament.

8. The method of claim 1, wherein the Christmas ornament further comprises both the energy harvesting device and the chargeable energy storage device.

9. The method of claim 1, wherein the Christmas ornament alternatively further comprises one or more additional electronic devices.

10. The method of claim 9, wherein the one or more additional electronic devices are also configured to be operatively associated with and powered by the said chargeable energy storage device, or wherein the additional electronic devices are configured to be operatively associated with and powered by a different and separate energy storage device.

11. The method of claim 9, wherein one or some of the one or more additional electronic devices are configured to be operatively associated with and powered by the said chargeable energy storage device while the other one or more additional electronic devices are configured to be operatively associated with and powered by a different and separate energy storage device.
